(19) United States
(12) Patent Application Publication
(10) Pub. No.: US 2010/0149050 A1
(43) Pub. Date: Jun. 17, 2010

(54) Antenna Device and a Portable Radio Communication Device Comprising Such An Antenna Device

(75) Inventors: Torsten Östervall, Stockholm (SE); Ulf Palin, Ljustero (SE)

Correspondence Address: HARNESS, DICKEY, & PIERCE, P.L.C, 7700 Bonhomme, Suite 400, ST. LOUIS, MO, 63105, US

(73) Assignee: Laird Technologies AB, Kista (SE)

(21) Appl. No.: 12/600,365

(22) PCT Filed: Apr. 29, 2008
(86) PCT No.: PCT/SE2008/050492

§ 371 Date: Nov. 16, 2009

(30) Foreign Application Priority Data
May 25, 2007 (EP) 07010469.0

(51) Int. Cl. H01Q 1/38; H01Q 1/24; H01Q 1/40; H01P 11/00

(52) U.S. Cl. 343/702; 343/700 MS; 343/873; 29/600

(57) ABSTRACT

The present invention relates to an antenna device comprising a dielectric carrier, a flexible film and a radiating element, wherein the flexible film is arranged on the dielectric carrier and the radiating element is arranged between the dielectric carrier and the flexible film.

### FIELD OF INVENTION

The present invention relates generally to antennas, and particularly to an antenna device for a portable radio communication device, such as a mobile phone or similar, comprising a flex film radiator.

### BACKGROUND

The market for portable radio communication devices, such as mobile phones, PDA, portable computers and similar devices, is today very competitive, which puts tough economical demands on the manufacturers. Furthermore, antennas of such devices many times only have access to limited space of different shapes.

One type of frequently used antenna for a portable radio communication device such as a mobile phone or similar is a so called flex film radiator, i.e. a radiating element on a flexible film of e.g. poly ethylene terephthalate (PET). An antenna device having a flex film radiator is often classified to have a too rough finish, even when lacquered, and a label is therefore attached thereon.

### SUMMARY OF THE INVENTION

An object of the present invention is to reduce the manufacturing costs for an antenna device having a flex film radiator for a portable radio communication device, and thus also for a portable radio communication device comprising such an antenna device.

This object, among others, is according to the present invention attained by an antenna device, a portable radio communication device, and a method for assembly an antenna device, respectively, as defined by the appended claims.

By providing an antenna device with a flex film radiator with its radiating element facing a dielectric carrier, a surface improving label for the antenna device can be omitted since the smooth side of the flexible film is facing out from the antenna device. Also, the RF yield of the antenna device is improved due to fewer components affecting the antenna device and the height of the antenna device is decreased, which is highly coveted today. Further, the flexible film of the antenna device is preferably non-transparent to provide e.g. color information. Additionally, the flexible film of the antenna device is preferably printed with information, by screen printing or similar. For increased finish a thin film is preferably laminated to the outer surface of the flexible film, which thin film can be provided with desired patterns.

The radiating element of the antenna device is preferably laminated to one side of the flexible film through an adhesive layer in order to position the radiating element strictly on the flexible film.

Further, the part of the radiating element facing the dielectric carrier is advantageously covered by a protective layer, such as a lacquer, to protect the radiating element against corrosion as well as to improve its aesthetic appearance.

The antenna device preferably comprises one or more discrete components on the flex film radiator, on the radiating element side thereof, which are positioned in indentations in the dielectric carrier, whereby they are provided without increasing the height of the antenna device, and consequently the height of the portable radio communication device. Further, such a discrete component can be positioned on the flex film radiator without the need to cut around the discrete component in order to fold it down into the indentation. The elimination of such cuts in the flex film radiator eliminates restrictions on trace routing to the discrete component and shorten the traces. Also, the indentation in the dielectric carrier can be made with smaller width compared to when a discrete component is folded down from the outer surface of a flex film radiator into the dielectric carrier. Yet further, with a small width of the indentation in the dielectric carrier the discrete component need not be supported by the dielectric carrier, and the indentation can even be made as a through hole.

Further features and advantages of the present invention will be evident from the following description.

### BRIEF DESCRIPTION OF THE DRAWINGS

The present invention will become more fully understood from the detailed description of embodiments given below and the accompanying figures, which are given by way of illustration only, and thus, are not limitative of the present invention, wherein:

FIG. 1 illustrates an antenna device having three connectors according to an embodiment of the present invention.

FIG. 2 schematically shows an exploded side of an antenna device according to an embodiment of the present invention.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

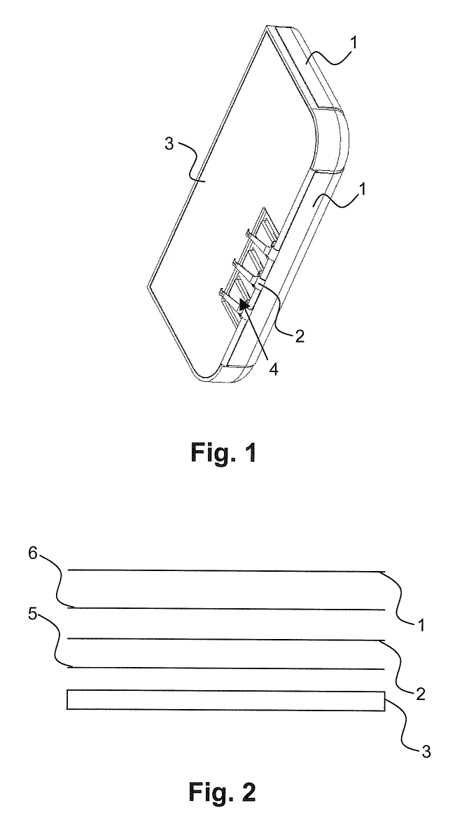

An embodiment of the present invention will now be described with reference to FIGS. 1-2.

An antenna device for a portable radio communication device, such as a mobile phone, a PDA, a portable computer or a similar device, comprises a flex film radiator on a dielectric carrier 3. The flex film radiator is preferably attached to the dielectric carrier 3 by means of an adhesive such as a tape or glue. The flex film radiator comprises a flexible film 1 and a radiating element 2 arranged thereon. The radiating element 2 is positioned on the side of the flexible film 1 that is facing the dielectric carrier 3, i.e. positioned between the dielectric carrier 3 and the flexible film 1.

The radiating element 2 is preferably made of rolled annealed copper, but could alternatively be made of e.g. silver or other material having similar properties, preferably laminated to the flexible film 1 through an adhesive layer 6. Alternatively, the radiating element 2 is added to the flexible film 1 by means of physical vapor deposition (PVD), by means of PVD and subsequent metallization, by means of printing and subsequent metallization, or similar technique. The radiating element 2 laminated to the flexible film 1 is preferably covered by a protective layer 5, such as a lacquer. The protective layer 5 is primarily for protection of the radiating element 2 prior to mounting to the dielectric carrier 3. An adhesive layer preferably used to attach the flex film radiator to the dielectric carrier 3 could alternatively be used as the protective layer 5.

The flexible film 1 is preferably made of PET, but could alternatively be made of e.g. poly ethylene napthalate (PEN), poly ether imide (PEI), poly imide (PI) or liquid crystal polymer (LCP). By having the flexible film 1 as the outermost surface of the antenna device the antenna device exhibits a high finish. Further, by preferably providing the flexible film 1 of a non-transparent PET, i.e. colored or modified, the radiating element 2 is not visible without use of a covering label. Additionally, the non-transparent flexible film 1 is preferably made in a color which either harmonizes with other parts of the portable radio communication device or is made with a color that e.g. classifies the flex film radiator according to applicable standards. In order to provide the flex film radiator, or the antenna device, with further information the flexible film 1 is preferably screen printed or similar with information such as product number, date, etc.

Yet an advantage with having the radiating element 2 facing the dielectric carrier 3 is that one or more discrete components can be mounted on the radiating element 2 and positioned in indentations in the dielectric carrier 3, whereby such components are added to the antenna device without increasing the height of the antenna device.

Preferably, the antenna device further comprises one or more connectors 4 contacting the radiating element 2, or contact portions thereof. The connectors 4 need to have portions positioned between the radiating element 2 and the dielectric carrier 3, since the outside of the flex film radiator is the non-conductive flexible film 1. A contact portion of the radiating element 2 can be arranged to be conductively connectable from the outside of the flex film radiator. Alternatively are contact means provided in e.g. a printed wiring board of the portable radio communication device, which contact means are arranged to connect to the antenna device.

Three connectors 4 are illustrated positioned in recesses in the underside of the dielectric carrier 3, or the side of the dielectric carrier opposite the side wherein the main part of the radiating element 2 is arranged, whereby minimum height building of the antenna device is achieved. The flex film radiator, or its flexible film 1, is also illustrated with portions thereof folded down over some parts of the circumferential part of the dielectric carrier 3. Contact portions 2 are folded from the circumferential part and arranged into the connectors 4. If the flex film radiator does not include a folded down portion toward the connectors 4 the contact portions 2 are folded from one side of the dielectric carrier 3 over its circumferential part and arranged into the connectors 4. The connectors 4 could alternatively be positioned on the surface of the underside of the dielectric carrier 3. Further, the connectors 4 have been described as positioned in the underside of the dielectric element 3 opposite the side wherein a major part of the flex film radiator is positioned, but could also be positioned on the same side of the dielectric element 3 as the flex film radiator or be positioned on the circumferential side of the dielectric element 3, preferably in recesses thereof.

The connectors 4 preferably have a resilient means for connection to a printed wiring board of the portable radio communication device.

A plurality of flex film radiators are preferably manufactured in the following way.

A plurality of radiating elements 2 is attached to an elongated flexible film by e.g. an adhesive layer 6, direct printing, PVD or similar technique, and formed into a roll. The desired pattern of each radiating element 2 is provided by etching, cutting or other known method. The radiating elements 2 are protected by means of a lacquer layer 5 and/or an adhesive layer 5 over the plurality of radiating elements 2. Alternatively, a plurality of radiating elements 2 are attached to a sheet of flexible film 1. Also, a thin film is easily added to the whole flexible film 1 to further improve the finish of the antenna device. Further, when the flex film radiators are manufactured in a reel to reel process, a liner for carrying each flex film radiator is preferably added and each flex film radiator is kiss cut, i.e. a cut is made towards the liner, but not through the liner.

A plurality of antenna devices is preferably manufactured in the following way.

A plurality of flex film radiators is cut out from the plurality of flex film radiators formed on the roll or the sheet and is put on a liner formed to a roll. Each radiator is taken from the liner in a reel to reel process and is put on a respective dielectric carrier. Also, when the liner is already during manufacturing of the flex film radiator roll, which in turn is kiss cut, this step is omitted during manufacturing of the antenna device.

A flex film radiator can e.g. comprise a plurality of radiating elements, each for use of one or more radio frequency bands (GSM900, GSM1800, satellite or similar), or comprise one radiating element for one or more radio frequency bands.

It will be obvious that the present invention may be varied in a plurality of ways. Such variations are not to be regarded as departure from the scope of the present invention as defined by the appended claims. All such variations as would be obvious for a person skilled in the art are intended to be included within the scope of the present invention as defined by the appended claims.

1. An antenna device comprising:
a dielectric carrier;
a flexible film; and
a radiating element
wherein said flexible film is arranged on said dielectric carrier; and
wherein said radiating element is arranged between said dielectric carrier and said flexible film.

2. The antenna device according to claim 1, wherein said radiating element is laminated to one side of said flexible film.

3. The antenna device according to claim 2, wherein the part of said radiating element facing said dielectric carrier is covered by a protective layer.

4. The antenna device according to claim 1, wherein said flexible film is non-transparent.

5. The antenna device according to claim 1, wherein said flexible film is printed to provide the antenna device with information.

6. The antenna device according to claim 1, comprising a discrete component on said radiating element positioned in an indentation in said dielectric carrier.

7. A portable radio communication device comprising an antenna device according to claim 1.

8. A method for manufacturing a plurality of antenna devices, the method comprising:
forming a plurality of flex film radiators by attaching a row of radiating elements to a flexible film;
cutting said plurality of flex film radiators into separate flex film radiators including separate radiating elements; and
attaching each of said plurality of flex film radiators to a dielectric carrier with said radiating element facing said dielectric carrier.

9. The method according to claim 8, wherein said step of forming a plurality of flex film radiator comprises laminating a high finish thin film to said flexible film.

10. The method according to claim 8, wherein:
said plurality of flex film radiators is arranged in a row of radiating elements attached to an elongated flexible film,
said step of forming a plurality of flex film radiator comprises laminating a liner to said flex film radiators, and
kiss cutting each of said plurality of flex film radiators.

11. The method according to claim 9, wherein:
the plurality of flex film radiators is arranged in a row of radiating elements attached to an elongated flexible film,
the step of forming a plurality of flex film radiator comprises laminating a liner to the flex film radiators, and
kiss cutting each of the plurality of flex film radiators.

12. The antenna device according to claim 1, wherein:
the flex film includes first and second generally oppositely facing sides; and
the radiating element is attached to the first side of the flexible film facing the dielectric carrier.

13. The antenna device according to claim 12, wherein the radiating element is adhesively attached to the first side of the flexible film.

14. The antenna device of claim 12, wherein the second side of the flex film is generally smooth and faces generally outwardly from the antenna device in a direction generally opposite the radiating element and dielectric carrier.

15. The antenna device according to claim 12, wherein one or more discrete components are on the first side of the flex film and positioned in corresponding one or more indentations in the dielectric carrier, the one or more indentations configured to allow the one or more discrete components to be added to the antenna device without increasing the height of the antenna device.

16. The antenna device according to claim 1, wherein the part of the radiating element facing the dielectric carrier is covered by a protective layer.

17. The antenna device according to claim 1, wherein the part of the radiating element facing the dielectric carrier is covered by lacquer.

18. A method relating to manufacturing a plurality of antenna devices, the method comprising:
attaching a plurality of radiating elements to a flexible film to form a plurality of flex film radiators;
separating the plurality of flex film radiators into separate flex film radiators including separate radiating elements; and
attaching each of the plurality of flex film radiators to a respective dielectric carrier with the radiating element facing the dielectric carrier.

19. The method according to claim 18, wherein the method includes:
adding a liner to the flex film radiators; and
kiss cutting each of said plurality of flex film radiators.

20. The method according to claim 18, wherein:
the separated plurality of flex film radiators are on a liner formed to a roll; and
each flex film radiator is taken from the liner in a reel to reel process and is put on a respective dielectric carrier.
